(19) United States
(12) Patent Application Publication
(10) Pub. No.: US 2026/0131708 A1
(43) Pub. Date: May 14, 2026

(54) CHILD SEAT PROTECTOR WITH BACK PANEL

(71) Applicant: MACNEIL IP LLC, Bolingbrook, IL (US)

(72) Inventors: Stephen KANE, Cedar Lake, IN (US); Keehoon YOO, Naperville, IL (US)

(73) Assignee: MACNEIL IP LLC, Bolingbrook, IL (US)

(21) Appl. No.: 18/944,323

(22) Filed: Nov. 12, 2024

(51) Int. Cl. B60N 2/60

(52) U.S. Cl. CPC B60N 2/60

(57) ABSTRACT

A protector integrally molded of a thermoplastic elastomer has a seat panel and a back panel. In use the seat panel conforms to a vehicle seat pan and the back panel conforms to a vehicle seat back. The back and seat panels are adapted to receive a child car seat thereon. Strap holes near the upper margin of the back panel may receive a strap for securing the upper margin of the back panel to the vehicle seat. A hinge panel joining the seat panel to the back panel may have one or more parallel grooves to create subpanels of the hinge panel, each of which may be at an angle to the others. The hinge panel may have a reduced width to permit access to child car seat anchors in the vehicle seat.

### BACKGROUND OF THE INVENTION

The field of the invention relates to apparatus for the protection of vehicle interiors, and more particularly to mats or liners for use with child car seats.

Small children are at risk of serious injury if the vehicles carrying them get into accidents. To mitigate this risk, child car seats are now universally used to secure small children in vehicles. The

car seats are secured in place to vehicle seats sized for adults, using buckles and straps, which attach the car seat to anchors provided by the vehicle manufacturers.

The small child, thus secured, nonetheless continues to be a source of damage to the vehicle interior, as does the now-weighted car seat itself. The weighted car seat may cause compression damage on the fabric or leather of the vehicle seat, while the small child may spill beverages or drop food. While child car seat protectors have been provided, currently there is no such protector that protects the vehicle seat back behind the child car seat.

### SUMMARY OF THE INVENTION

According to one aspect of the invention, a protector for protecting a vehicle seat is adapted for use with a child car seat. The protector is integrally molded of an elastomer and comprises a seat panel and a back panel. A first hinge panel joins a lower margin of the back panel to a rear margin of the seat panel. Fastening means formed adjacent to an upper margin of the back panel are used to attach the upper margin of the back panel to the vehicle seat back. In use, the back panel substantially conforms to the seat back, while the seat panel substantially conforms to a seat pan of the vehicle seat. In use, an angle of the back panel to the seat panel will be substantially similar to an angle of the seat back to the seat pan. The back panel and the seat panel are adapted to receive a child car seat thereon.

According to another aspect of the invention, a protector is provided for protecting a vehicle seat and for use with a child car seat. The protector is integrally molded of an elastomer and includes a seat panel and a back panel. A first hinge panel connects a rear margin of the seat panel to a lower margin of the back panel. The first hinge panel is divided into a plurality of subpanels including first and second subpanels. The first hinge panel has a first face for facing the vehicle seat and an opposed second face for facing the child car seat. A first groove is formed in the first face to be transversely oriented, and divides the first subpanel from the second subpanel. The first hinge panel preferentially folds at the first groove such that the first subpanel may be at a different angle to the horizontal than the second subpanel. In use, the back panel substantially conforms to a vehicle seat back while the seat panel substantially conforms to a vehicle seat pan. An angle of the seat panel to the back panel will be substantially the same as the angle of the vehicle seat back to the vehicle seat pan. The seat panel and back panel are adapted to receive a child car seat thereon.

In one embodiment, the first hinge panel further includes a second groove and a third groove, both spaced from and disposed substantially in parallel to the first groove. The second groove divides the first subpanel from the seat panel. The third groove divides the second subpanel from the back panel. The first hinge panel preferentially folds at any or all of these grooves, so as to permit the substantial conformance of the seat panel to the vehicle seat pan while at the same time permitting the substantial conformance of the back panel to the vehicle seat back.

In a further aspect of the invention, a child seat protector is integrally molded from an elastomer. The child seat protector includes a seat panel for substantial conformance to a vehicle seat pan, and a back panel for substantial conformance to a vehicle seat back. A first hinge panel joins the seat panel to the back panel. The first hinge panel has a first face which in use faces a child car seat, and an opposed, second face which in use faces the vehicle seat. A first, transversely oriented groove is formed in the second face and divides the first hinge panel from the seat panel. A second, transversely oriented groove is formed in the second face to be spaced from and substantially parallel to the first groove. The second groove divides the first hinge panel from the back panel. In use the first hinge panel preferentially folds at the first groove, the second groove, or both, so as to fit to seat pans having different longitudinal depths.

In any of the above aspects, the protector may further include a front panel which in use covers a front of the vehicle seat. A second hinge panel joins an upper margin of the front panel to the front margin of the seat panel.

In any of the above aspects, the protector may further include a left panel which transversely leftwardly extends from a left margin of the seat panel, and a right panel which transversely rightwardly extends from a right margin of the seat panel. These left and right panels are positioned to catch food, spills and other detritus from the child secured in the child car seat. Either of these right and left panels may be trimmed off by the consumer in instances where the vehicle seat pan has a narrow width.

In any of the above aspects, the protector may be injection molded from a thermoplastic elastomer.

### BRIEF DESCRIPTION OF THE DRAWINGS

Further aspects of the invention and their advantages can be discerned in the following detailed description as read in conjunction with the drawings of an exemplary embodiment, in which like characters denote like parts and in which:

FIG. 1 is a top front left perspective view of a seat protector according to the invention in a flat, as-molded condition;

FIG. 2 is a bottom view of the protector shown in FIG. 1;

FIG. 3 is a longitudinal sectional detail taken substantially along Line 3-3 of FIG. 1;

FIG. 4 is a top left perspective view of the seat protector shown in FIG. 1, but folded into a typical use configuration that it would take while protecting a vehicle seat;

FIG. 4A is a three-axis frame of reference oriented to the view seen in FIG. 4;

FIG. 5 is a longitudinal sectional detail of a hinge panel, in the condition it assumes when the protector is folded to the configuration shown in FIG. 4;

FIG. 6 is a front left perspective view of the seat protector shown in FIGS. 1 and 4, as installed on a vehicle seat with a child car seat installed on top of the seat protector, with parts of the vehicle broken away;

FIG. 6A is a perspective detail of FIG. 6, showing a physical relationship of the hinge panel to a child car seat anchor and strap; and

FIG. 6B is a perspective detail of FIG. 6, showing a strap for fastening a top margin of a protector seat back panel to a vehicle headrest.

### DETAILED DESCRIPTION

As used herein, “longitudinal” means in parallel to a direction of vehicle travel when the vehicle is moving in a straight line. “Longitudinal”, or fore-and-aft, is parallel to axis 400 as seen in FIG. 4A. “Forward” and “rearward” are directions opposed to each other and both parallel to axis 400. “Transverse” is a direction that is horizontal and is at 90 degrees to the “longitudinal” direction. “Transverse” is side-to-side, or inboard-outboard. A “transverse” direction is parallel to axis 402 as seen in FIG. 4A. “Right” and “left” are directions opposed to each other and in parallel to axis 402. “Vertical” means up-and-down, and is a direction at ninety degrees to a horizontal plane, and to “longitudinal” and “transverse”. A “vertical” direction is parallel to axis 404 as seen in FIG. 4A. “Upward” and “downward” are directions opposed to each other and both parallel to axis 404.

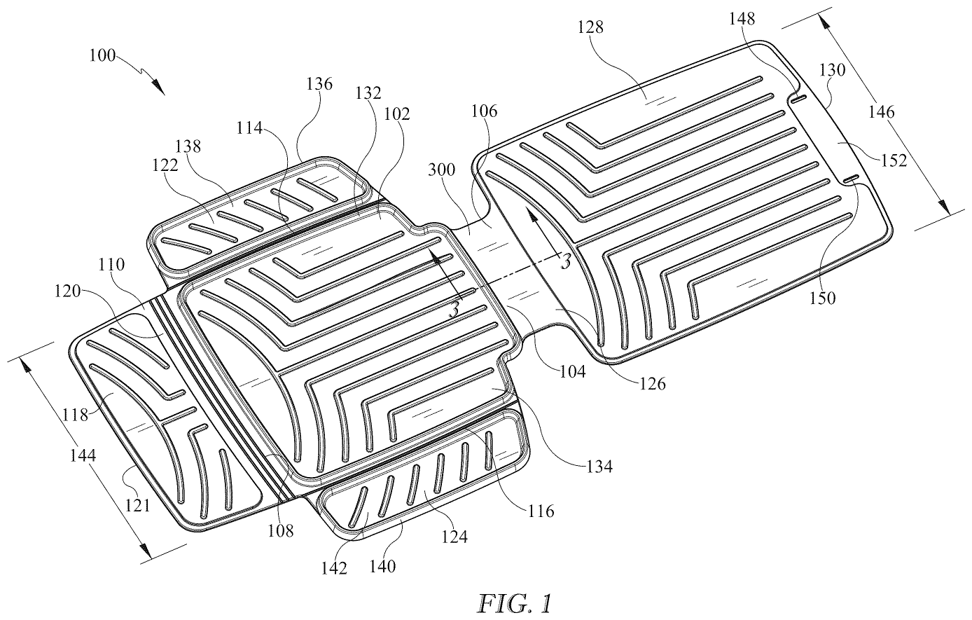

A child seat protector is indicated generally at 100 in FIG. 1, in a flat and as-molded configuration. Protector 100 may be integrally molded of an elastomer, and more particularly may be integrally injection-molded of a thermoplastic elastomer (TPE).

Protector 100 includes a seat panel 102 that, in use, will be laid on an upper surface of a vehicle seat. In the illustrated embodiment, the seat panel 102 is roughly rectangular. A rear margin 104 of the seat panel 102 is connected to a first hinge panel 106. A front margin 108 of the seat panel 102 is connected to a second hinge panel 110. A right margin 114 of the seat panel 102 extends between rear margin 104 and front margin 108. An opposed left margin 116 of the seat panel 102 likewise extends between rear margin 104 and front margin 108.

In the flat configuration shown in FIG. 1, a front panel 118 of the protector is connected to second hinge panel 110 at a “top” margin 120 of the second hinge panel and forwardly extends therefrom to a “bottom” margin 121 of the front panel 118. A right panel 122 transversely rightwardly extends from seat panel right margin 114. A left panel 124 transversely leftwardly extends from seat panel left margin 116.

In the configuration shown in FIG. 1, the first hinge panel 106 rearwardly extends from rear margin 104 of the seat panel 102 to a “bottom” margin 126 of a back panel 128. Back panel 128, in this configuration, rearwardly extends to a “top” margin 130 thereof.

A continuous peripheral rib 132 upwardly extends from a general upper surface 134 of the seat panel 102 and is located at or near seat panel margins 104, 108, 114 and 116. The peripheral rib 132 creates a reservoir for any spilled liquids and food particles, and impedes or prevents same from flowing or falling on to the vehicle seat surface. Similarly, the right panel 122 may have a continuous rib 136 positioned at or near its lateral periphery, and which upwardly extends from a general upper surface 138 of the right panel 122. In like manner the left panel 124 may have a continuous peripheral rib 140 which upwardly extends from a general upper surface 142 of the left panel 124. Ribs 136 and 140 create auxiliary reservoirs or catch basins for receiving and retaining spilled liquids, crumbs and the like.

The seat panel 102 may have a width 144 in a transverse direction that is chosen to be greater than the width of most commercial child car seats. Width 144 may, for example, be about 18 in. In like manner, the back panel 128 may have a width 146 in the transverse direction that is chosen to be greater than the width of the back of most commercial child car seats. Width 146 may, for example, be about 18 in.

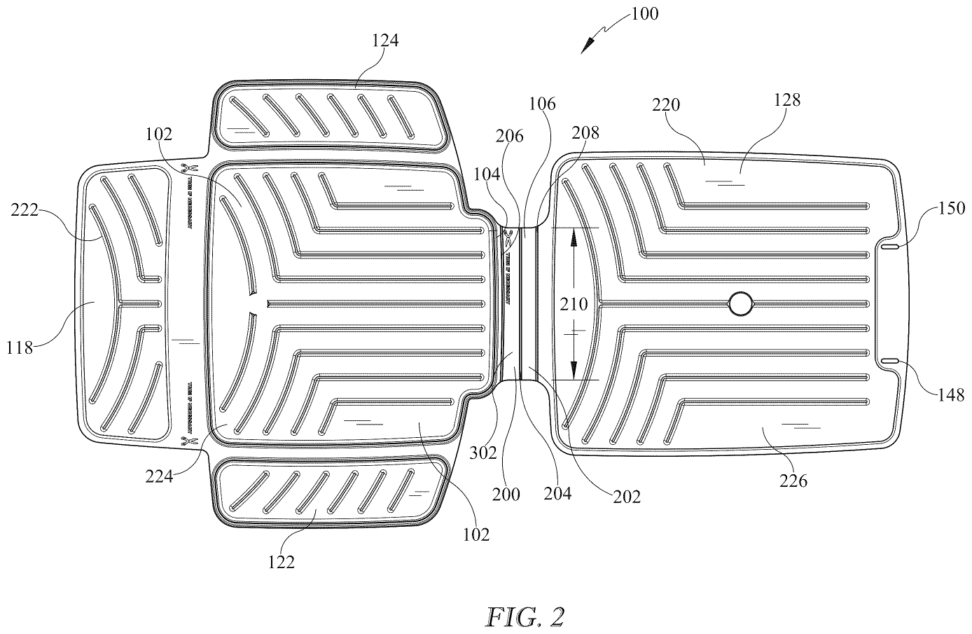

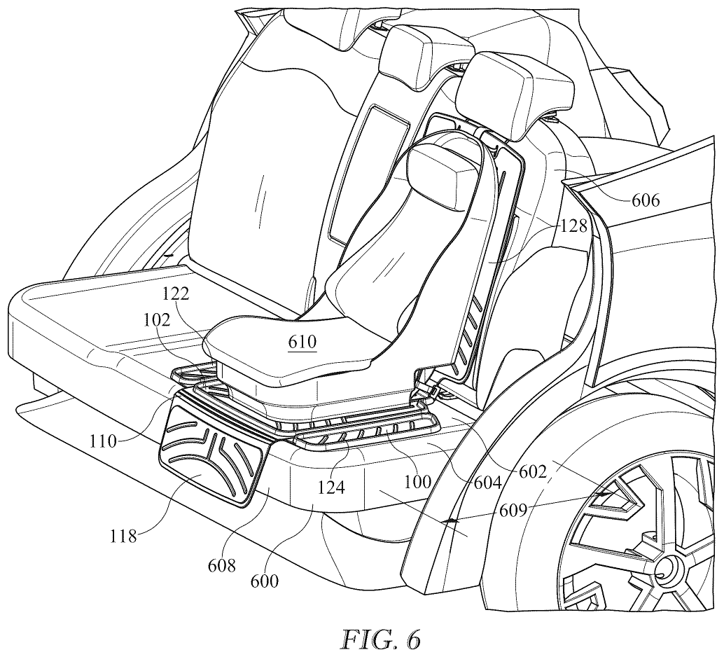

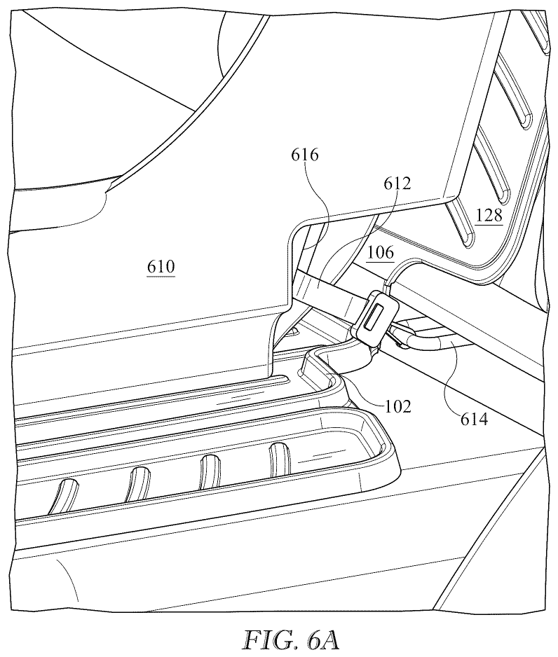

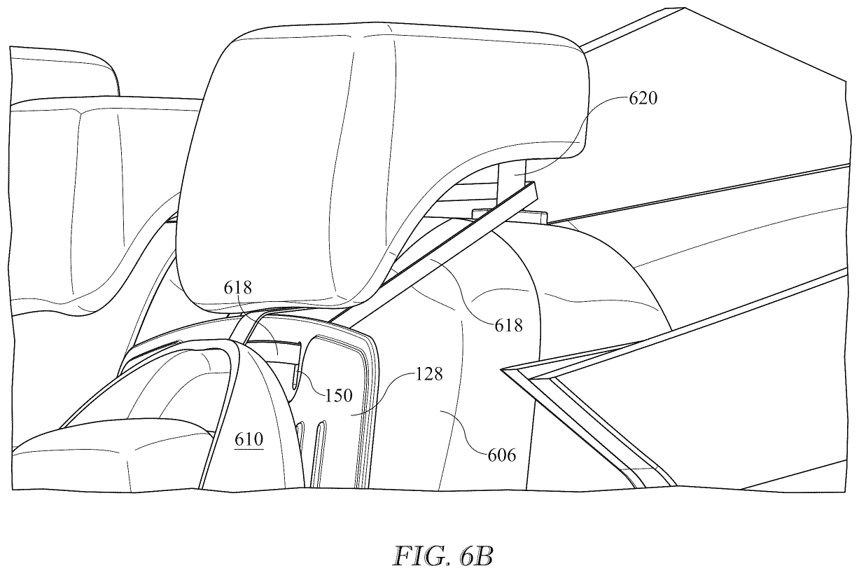

A pair of slots 148 and 150 may be formed to be transversely spaced apart from each other and near the top margin 130 of the back panel 128. As will be hereinafter described, the slots 148, 150 each extend from a forward-facing surface 152 to a rearward-facing surface 226 (FIG. 2) of the back panel 128. Slots 148, 150 receive a strap (not shown in FIG. 1; see FIG. 6B) that is used to secure the top margin 130 of the back panel 128 to an upper portion of a vehicle seat back, such as a headrest. Other methods of affixation of the back panel 128 to the vehicle seat back could be used, such as snaps or hook-and-loop material.

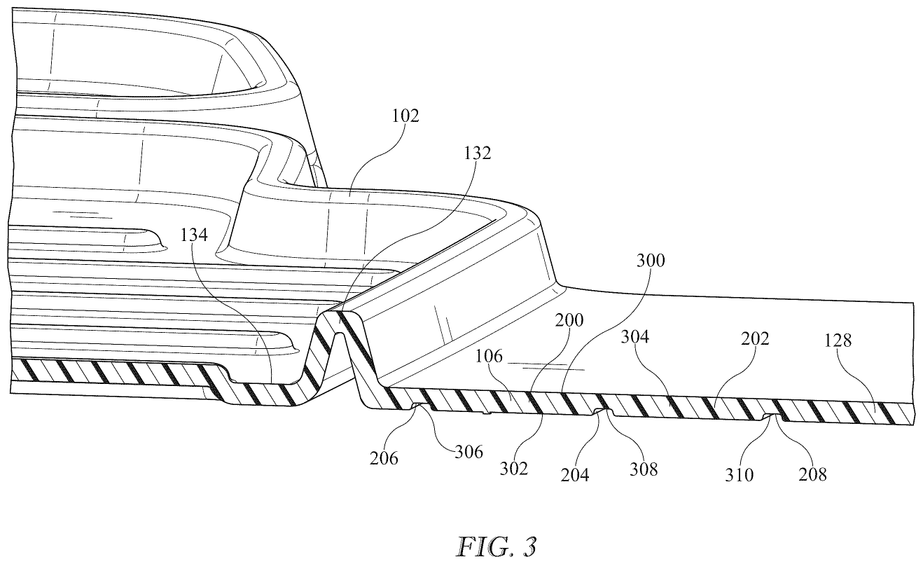

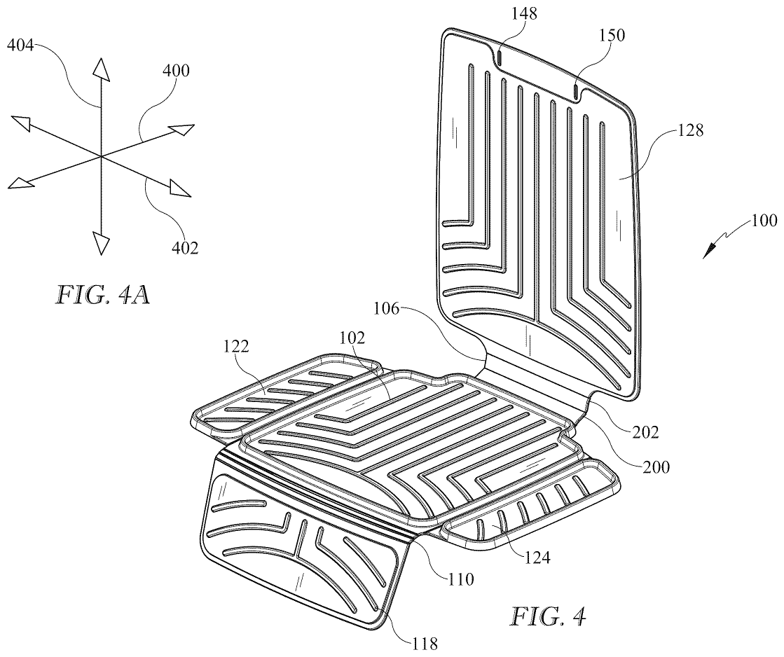

As seen in FIGS. 2 and 3, the first hinge panel 106 is divided into a first subpanel 200 and a second subpanel 202 by a groove 204. The first subpanel 200 is divided from seat panel 102 by a groove 206, and the second subpanel 202 is divided from back panel 128 by a groove 208. The grooves 204, 206, 208 are longitudinally spaced apart from each other when protector 100 is in a flat configuration, are substantially straight and are oriented transversely.

The first hinge panel 106 has a width 210 in a transverse direction that is substantially less than panel widths 144 and 146. Width 210 can be about 9.5 in. In any event, width 210 should be smaller than the standardized transverse spacing of vehicle child seat anchors, which is 11 in.

FIG. 2 shows the protector 100 in a flat, as-molded condition. Visible here is a surface 220 which in use will face the vehicle seat 600 (FIG. 6). The seat-facing surface 220 includes a seat-facing surface 222 of the front panel 118, a seat-facing surface 224 of the seat panel 102, a seat-facing surface 302 of the first hinge panel 106 and a seat-facing surface 226 of the back panel 128. The opposed upper surfaces of protector 100 seen in FIG. 1, including surface 134 and 300, in use will be facing the child car seat 610 (FIG. 6).

As seen in FIG. 3, the first hinge panel 106 has an upper surface 300 which (in a flat configuration) is substantially planar. The first hinge panel 106 has a general lower surface 302 which, in a flat configuration, is also substantially planar. The grooves 206, 204 and 208 each upwardly extend from general surface 302 into the body 304 of the first hinge panel 106, terminating at respective ceilings 306, 308 and 310. A thickness of the body 304 between the ceilings 306-310 and hinge panel upper surface 300 may be about 0.085 in. A thickness of the body 304 between upper surface 300 and general lower surface 302 may be about 0.125 in., and this may also be the nominal thickness of the entire protector 100.

Grooves 206, 204 and 208 are made in the lower surface of first hinge panel 106 so that the first hinge panel 106 will preferentially fold at these grooves. A vertical depth of the grooves 204-208 may range from about 0.025 in. to about 0.05 in. The depth of the grooves may vary as a function of the flexibility of the elastomer used and the total thickness of panel 106.

Also visible in FIG. 3 is peripheral rib 132 of seat panel 102, which as shown may be made hollow for best moldability. Peripheral ribs 136 and 140 may be formed similarly.

FIG. 4 show the protector 100 in a typical configuration it would assume during use. The plane of seat panel 102 may be horizontal or tilted somewhat upwardly and forwardly, as shown. The plane of back panel 128 may be vertical, as shown, or may be somewhat rearwardly and upwardly inclined. Front panel 118 will cover a front 608 (not shown in FIG. 4; see FIG. 6) of the vehicle seat 600, but may not conform to it closely.

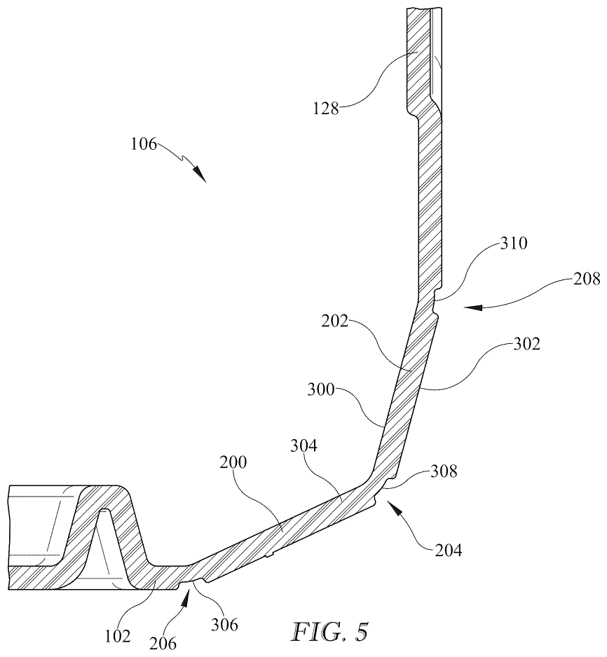

To accomplish this, the protector 100 is folded at first and second hinge panels 106 and 110. Front panel 118 is folded downward at second hinge panel 110, while back panel 128 is folded upward at hinge panel 106. As seen in FIG. 5, the grooves 206, 204 and 208 permit the subpanels 200 and 202 to reside in planes which are at an angle to each other, and at angles to the planes occupied by seat panel 102 and back panel 128. Where folding occurs at one or more of the grooves 206, 204, 208, then at those grooves, the ceilings 306, 308 and/or 310 will no longer be planar but will take on an upwardly or forwardly concave arcuate shape. The upper/forward surface 300 of panel 106 will become upwardly or forwardly concavely arcuate as well at locations opposite those ceilings.

While as seen in FIG. 5, the first hinge panel 106 is folded at each of grooves 206, 204 and 208, in other situations, folding could occur at only one or two of these grooves. Such might be the case where the length or depth 609 (in the longitudinal direction) of the seat pan 604 or surface on which seat panel 102 is residing is large, such that the plane occupied by back panel 128 is rearwardly displaced from the position shown. Then most or all the folding would occur at groove 208. Alternatively, and where the length 609 (FIG. 6) of the seat pan 604 is small, the plane of the back panel 128 will be disposed forwardly from the position shown in FIG. 4, and most of the folding will occur at groove 206.

In alternative embodiments (not shown), there could be more or fewer grooves. For example, the first hinge panel 106 could have only a first groove (such as groove 206) dividing it from the seat panel 102, and a second groove (such as groove 208) dividing it from the back panel 128. The degree of folding at either of these grooves would be a function of the longitudinal depth 609 of the seat pan 604 on which the seat panel 102 is placed.

FIG. 6 shows a protector 100 as installed on a vehicle seat 600. Seat panel 102 is disposed on an upper surface 602 of a seat portion or pan 604 of vehicle seat 600. Back panel 128 is disposed to be adjacent to a forwardly facing surface of a seat back 606 of the vehicle seat 600. The front panel 118 extends downwardly so as to cover a portion of a front 608 of the vehicle seat 600.

The seat pan 604 has a longitudinal depth 609 which may vary from one vehicle model to the next. Folding at one or more of the grooves 204-208 permits the protector 100 to fit to different seat pans, such as ones having a longitudinal depth 609 between about 17.5 in. and about 21 in.

Left panel 124, and right panel 122, are also laid on seat pan 604. For some vehicle models, the seat pan 604 will be too narrow in a transverse direction for one or more of the left and right seat panels 124, 122 to be used. In such an instance, one or more of the left and right seat panels 124, 122 is simply trimmed off of the protector 100 by the user. This may be the case in particular for that one of the panels 124, 122 that is disposed on the outboard side of the vehicle seat 600. In like fashion the user may trim off the front panel 118 and/or the back panel 128. These trimming actions may be accomplished with scissors.

Then, a child car seat 610 is placed on the protector seat panel 102 and adjacent to back panel 128. As seen in FIG. 6A, a strap 612 is attached to a car seat anchor 614. The strap 612 is fed through a channel 616 in the car seat 610 to the other side (not shown) where another end of the strap 612 is fastened to an anchor similar to anchor 614. The reduced width 210 of first hinge panel 106 permits the user to easily access the seat anchors, including anchor 614.

As seen in FIG. 6B, a strap 618 is fed through slot 150 (and through slot 148) in the back panel 128. The strap is then secured to an anchoring point on the seat back 606, such as around headrest posts 620. This firmly secures back panel 128 to the vehicle seat back 606.

The protector 100 of the invention mitigates against indentations being made in the upholstered vehicle seat pan 604 and back 606, and provides a barrier to fluids, crumbs etc. impinging on both of these structures.

In summary, a child seat protector has been shown and described that includes a back panel for protecting the vehicle seat back. A hinge panel connects the back panel to a seat panel, and the hinge panel may be preferentially folded at one or more grooves formed in or bounding the hinge panel. This permits the child seat to fit to vehicle seats having different dimensions.

While embodiments of the present invention have been described and/or illustrated in the appended drawings, the present invention is not limited thereto but only by the scope and spirit of the appended claims.

We claim:

1. A protector for protecting a vehicle seat for use with a child car seat, the protector integrally molded of an elastomer and comprising:
a seat panel having a front margin and a rear margin;
a back panel having a lower margin and an upper margin; fastening means disposed adjacent the upper margin of the back panel for affixing the upper margin of the back panel to a vehicle seat back; and
a first hinge panel joining the rear margin of the seat panel to the lower margin of the back panel,
whereby in use the back panel substantially conforms to the vehicle seat back and the seat panel substantially conforms to a seat surface of the vehicle seat, an angle of the seat panel to the back panel being substantially the same as an angle of the vehicle seat back to the vehicle seat surface, the seat panel and back panel adapted to receive a child car seat thereon.

2. The protector of claim 1, wherein the seat panel has a front margin, the protector further comprising a front panel having an upper margin, a second hinge panel of the protector joining the front margin of the seat panel to the upper margin of the front panel, the front panel in use covering a front of the vehicle seat.

3. The protector of claim 1, wherein the fastening means comprises at least one slot formed through the back panel so as to be adjacent the upper margin of the back panel.

4. The protector of claim 3, wherein the least one slot is one of first and second slots formed through the back panel so as to be adjacent the upper margin of the back panel, the first and second slots transversely spaced apart from each other and adapted to receive therethrough a fastening strap, the fastening strap used to affix the upper margin of the back panel to the vehicle seat back.

5. The protector of claim 1 wherein the seat panel, back panel and first hinge panel each have respective widths in a transverse direction, the width of the first hinge panel being smaller than the width of the seat panel and smaller than the width of the back panel, such that in use the first hinge panel does not cover child car seat anchors of the vehicle seat.

6. The protector of claim 5, wherein the width of the first hinge panel is about 9.3 in.

7. The protector of claim 1, wherein the seat panel has a front margin opposed to the rear margin, a left margin extending between the front and rear margins of the seat panel and a right margin opposed to the left margin and extending between the front and rear margins of the seat panel, the protector further comprising a left panel transversely extending from the left margin and a right panel transversely extending from the right margin, the left and right panels adapted to catch detritus from a child secured in a car seat placed on top of the seat panel.

8. The protector of claim 1, wherein the first hinge panel has a first face for facing the child car seat and an opposed second face for facing the vehicle seat, at least one transversely oriented groove formed in the second face of the first hinge panel to divide the first hinge panel into a first subpanel closer to the seat panel and a second subpanel closer to the back panel, the first hinge panel preferentially bending at the groove such that the first subpanel may be at an angle to the second subpanel.

9. The protector of claim 8, wherein the groove is a first groove of a plurality of grooves, the grooves being spaced from each other and substantially in parallel to each other and defining a number of subpanels which is one less than a number of the grooves, the first hinge panel capable of bending at each of the grooves so that each subpanel may be at an angle to the other subpanels.

10. The protector of claim 9, wherein the number of grooves is three and the number of subpanels is two.

11. The protector of claim 1, wherein the protector is integrally molded from a thermoplastic elastomer.

12. A protector for protecting a vehicle seat for use with a child car seat, the protector integrally molded of an elastomer and comprising:
a seat panel having a front margin and a rear margin;
a back panel having a lower margin and an upper margin; and
a first hinge panel joining the seat panel to the back panel, the first hinge panel having a first face for facing the vehicle seat and an opposed second face for facing the child car seat, wherein
the first hinge panel is divided into a plurality of subpanels including first and second subpanels, a first groove formed in the first face of the first hinge panel to be transversely oriented, the first groove dividing the first subpanel from the second subpanel, the first hinge panel preferentially folding at the first groove such that the first subpanel may be at a different angle to the horizontal than the second subpanel;
whereby in use the back panel substantially conforms to a vehicle seat back, the seat panel substantially conforms to a vehicle seat pan, an angle of the seat panel to the back panel being substantially the same as an angle of the vehicle seat back to the vehicle seat pan, the seat panel and back panel adapted to receive a child car seat thereon.

13. The protector of claim 12, wherein the first hinge panel further includes a second groove disposed to be spaced from and substantially in parallel to the first groove, and a third groove disposed to be spaced from and substantially in parallel to the first groove, the second groove dividing the first subpanel from the seat panel, the third groove dividing the second subpanel from the back panel, the first hinge panel preferentially folding at one or more of the first, second and third grooves to permit the substantial conformance of the seat panel to the seat pan and the substantial conformance of the back panel to the vehicle seat back.

14. The protector of claim 12, wherein the protector is integrally molded of a thermoplastic elastomer.

15. The protector of claim 12, wherein the first hinge panel has a width in a transverse direction, the seat panel has a width in the transverse direction and the back panel has a width in the transverse direction, the width of the first hinge panel being smaller than the width of the seat panel and being smaller than the width of the back panel so that vehicle seat car seat anchors may be accessed.

16. The protector of claim 12, further comprising a front panel with an upper margin, a second hinge panel joining the upper margin of the front panel to the front margin of the seat panel, the front panel in use substantially conforming to a front of the vehicle seat.

17. The protector of claim 12, wherein the seat panel has a left margin extending from the front margin to the rear margin and a right margin opposed to the left margin and extending from the front margin to the rear margin, a right panel extending transversely rightward from the right margin of the seat panel, a left panel extending transversely leftward from the left margin of the seat panel.

18. A child car seat protector integrally formed of an elastomer and comprising:
a seat panel for substantial conformance to a vehicle seat pan;
a back panel for substantial conformance to a vehicle seat back; and
a hinge panel connecting the seat panel to the back panel, the hinge panel having a body, a car seat-facing surface and an opposed vehicle seat-facing surface, a first groove formed to extend into the body from the vehicle seat-facing surface and dividing the hinge panel from the seat panel, a second groove formed to extend into the body from the vehicle seat-facing surface and dividing the hinge panel from the back panel, the first and second grooves being substantially oriented transversely and longitudinally spaced apart from each other, whereby in use the hinge panel may preferentially fold at one or both of the first and second grooves such that the seat panel substantially conforms to the vehicle seat pan while the back panel substantially conforms to the vehicle seat back.

19. The child car seat protector of claim 18, wherein the seat panel has a seat panel width in a transverse direction, the back panel has a back panel width in the transverse direction and the hinge panel has a hinge panel width in the transverse direction, the hinge panel width being less than the seat panel width and the back panel width so that, in use, a user may access child car seat anchors in the vehicle seat.
